(19) United States
(12) Patent Application Publication
(10) Pub. No.: US 2015/0070415 A1
(43) Pub. Date: Mar. 12, 2015

(54) LIQUID EJECTING APPARATUS AND LIQUID CIRCULATION METHOD OF LIQUID EJECTING APPARATUS

(71) Applicant: TOSHIBA TEC KABUSHIKI KAISHA, Tokyo (JP)

(72) Inventors: Hiroyuki Ishikawa, Kannami (JP); Masashi Hiroki, Yokohama (JP); Kazuhiro Hara, Numazu (JP)

(21) Appl. No.: 14/461,518

(22) Filed: Aug. 18, 2014

(30) Foreign Application Priority Data
Sep. 10, 2013 (JP) 2013-187565

(51) Int. Cl. B41J 2/175

(52) U.S. Cl. CPC B41J 2/175
USPC 347/6

(57) ABSTRACT

A liquid ejecting apparatus includes a liquid ejecting head that ejects liquid from an ejection portion; a tank that stores the liquid; a circulation transportation portion that includes a first transportation portion for transporting liquid from the tank to the liquid ejecting head, and a second transportation portion for transporting the liquid from the liquid ejecting head to the tank; an actuator that circulates the liquid of the circulation transportation portion; and a control portion that controls the actuator so as to maintain pressure in the liquid ejecting head to be negative pressure with respect to atmospheric pressure when circulation of the liquid in the circulation transportation portion is started and to start the circulation of the liquid after the pressure in the liquid ejecting head is increased.

### CROSS-REFERENCE TO RELATED APPLICATION

This application is based upon and claims the benefit of priority from Japanese Patent Application No. 2013-187565, filed Sep. 10, 2013, the entire contents of which are incorporated herein by reference.

### FIELD

Embodiments described herein relate generally to a liquid circulation-type liquid ejecting apparatus and a liquid circulation method of the liquid ejecting apparatus.

### BACKGROUND

There is a liquid circulation-type liquid ejecting apparatus that removes bubbles included in liquid by circulating the liquid between a liquid tank and a liquid ejecting head.

However, in the liquid circulation-type liquid ejecting apparatus, it is concerned that the pressure in the liquid ejecting head is drastically decreased by absorption pressure by a circulation pump when the circulation of the liquid is started in order to remove the bubbles. If the pressure in the liquid ejecting head is greatly decreased, when the circulation of the liquid is started, it is concerned that an ejection head absorbs the air from a nozzle.

JP-A-2005-125670 is an example of the related art.

### DESCRIPTION OF THE DRAWINGS

FIG. 1 is a configuration diagram schematically illustrating an ink circulation mechanism of an inkjet printer according to a first embodiment.

FIG. 2 is a view schematically illustrating a structure in a circumference of a nozzle of an inkjet head according to the first embodiment.

FIG. 3 is a block diagram schematically illustrating a control system that mainly controls the ink circulation mechanism of the inkjet printer according to the first embodiment.

FIG. 4 is a diagram illustrating an example of pressure fluctuations in an ink chamber when circulation of ink is started by the ink circulation mechanism according to the first embodiment.

FIG. 5 is a flow chart illustrating control of the circulation of the ink according to the first embodiment.

FIG. 6 is a timing chart illustrating the control of the circulation of the ink according to the first embodiment.

FIG. 7 is a flow chart illustrating control of circulation of ink according to a second embodiment.

FIG. 8 is a timing chart illustrating the control of the circulation of the ink according to the second embodiment.

FIG. 9 is a timing chart illustrating the control of circulation of ink according to a comparative example.

### DETAILED DESCRIPTION

An object of an exemplary embodiment is to provide a liquid ejecting apparatus and a liquid circulation method of the liquid ejecting apparatus in which liquid ejecting performance is favorably maintained by preventing absorption of bubbles from a nozzle when circulation of liquid is started in order to remove bubbles or foreign substances mixed into the liquid.

In order to achieve the object, a liquid ejecting apparatus according to the embodiment includes a liquid ejecting head that ejects liquid from an ejection portion; a tank that stores the liquid; a circulation transportation portion that includes a first transportation portion for transporting liquid from the tank to the liquid ejecting head, and a second transportation portion for transporting the liquid from the liquid ejecting head to the tank; an actuator that circulates the liquid of the circulation transportation portion; and a control portion that controls the actuator so as to maintain pressure in the liquid ejecting head to be negative pressure with respect to atmospheric pressure when circulation of the liquid in the circulation transportation portion is started and to start the circulation of the liquid after the pressure in the liquid ejecting head is increased.

### First Embodiment

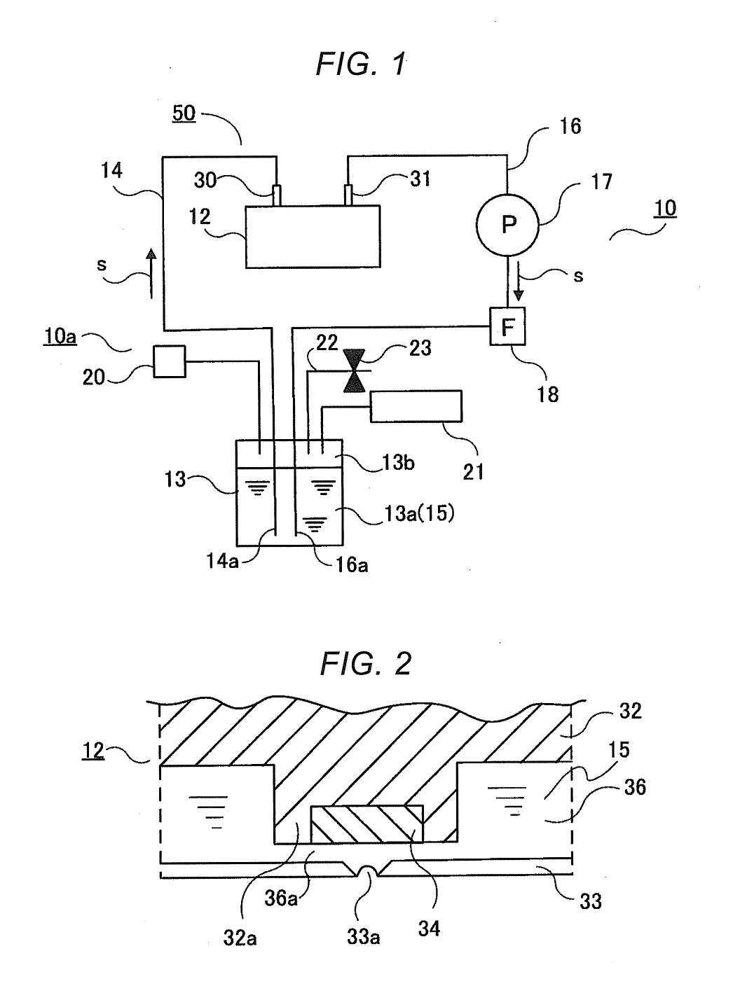

An inkjet printer that forms an image on a recording medium by ejecting ink is described with reference to FIGS. 1 to 6, as an example of a liquid ejecting apparatus according to a first embodiment. The ink circulation mechanism 10 of the inkjet printer 50 illustrated in FIG. 1 includes an inkjet head 12 which is a liquid ejecting head, and an ink tank 13 which is a tank that stores ink 15 which is liquid. The ink circulation mechanism 10 includes an ink supply path 14 which is a first transportation portion, an ink circulation channel 16 which is a second transportation portion, a circulation pump 17 which is a transportation pump, a filter 18, a pressure sensor 20, a pressure adjustment pump 21, an air communication passage 22, and an electromagnetic valve 23. The circulation pump 17 and the pressure adjustment pump 21 configure an actuator. The ink circulation mechanism 10 is tightly sealed from the air.

The inkjet head 12 includes an inflow port 30 connected to the ink supply path 14, and an outflow port 31 connected to the ink circulation channel 16. The inkjet head 12 includes a head body 32, a nozzle plate 33 on which a nozzle 33a which is an ejection portion is formed, and an actuator 34, as illustrated in FIG. 2. (The plurality of nozzles 33a are formed on the nozzle plate 33, but one nozzle 33a is illustrated in FIG. 2. The nozzle plate 33 includes the actuator 34 for each nozzle 33a.)

The inkjet head 12 includes an ink chamber 36 formed in the head body 32. The ink chamber 36 is conductively connected to the inflow port 30 and the outflow port 31. The inkjet head 12 includes the actuator 34 in a protruding portion 32a formed on the head body 32. The actuator 34 is configured with a piezoelectric element such as a piezo (PZT) element. In the ink chamber 36, a gap between the actuator 34 and the nozzle plate 33 is narrow in an arrangement area 36a of the actuator 34. The arrangement area 36a of the actuator 34 in the ink chamber 36 has a smaller cross section of an ink channel than that of the other areas.

The inkjet head 12 forms a piezoelectric element by applying a voltage to the piezoelectric element of the actuator 34, generates the pressure fluctuation in the ink 15 in the ink chamber 36, and ejects an ink drop from the nozzle 33a. The actuator 34 of the inkjet head 12 is not limited to the piezoelectric element, and may have a configuration in which an ink drop is ejected from the nozzle 33a by using thermal energy such as a heater.

The ink tank 13 includes an ink layer 13a formed of the ink 15 and an air space 13b inside the ink tank 13. An upstream end 14a of the ink supply path 14 and a downstream end 16a of the ink circulation channel 16 exist in the ink layer 13a. For example, bubbles mixed in the ink 15 from the nozzle 33a in the inkjet head 12 are collected into the ink tank 13 through the ink circulation channel 16, and are absorbed into the air space 13b in the ink tank 13. For example, a flexible resin tube or a metal pipe formed of stainless steel or the like is used as the ink supply path 14 and the ink circulation channel 16.

The circulation pump 17 exists in the ink circulation channel 16. The circulation pump 17 circulates the ink 15 in a circulation direction indicated by an arrow s in the circulation channel 10a including the inkjet head 12, the ink tank 13, the ink supply path 14, and the ink circulation channel 16. For example, a tube pump, a diaphragm pump, or a piston pump is used as the circulation pump 17.

The filter 18 exists on the downstream of the circulation pump 17 of the ink circulation channel 16 in the circulation direction and removes foreign substances mixed in the ink 15. For example, a mesh filter formed of polypropylene, nylon, polyphenylene sulfide, or stainless steel or the like is used as the filter 18.

The pressure sensor 20 detects pressure of the air space 13b of the ink tank 13. The pressure sensor 20 uses, for example, a semiconductor piezoresistance pressure sensor. The semiconductor piezoresistance pressure sensor includes a diaphragm that receives pressure from the outside, and a semiconductor strain gauge formed on a surface of the diaphragm, and detects the pressure by converting a change of an electric resistance caused by a piezoresistance effect generated by the strain gauge according to the deformation of the diaphragm caused by the pressure from the outside into an electric signal.

The pressure adjustment pump 21 sends the air into the ink tank 13, and increases the pressure in the circulation channel 10a. The pressure adjustment pump 21 uses, for example, a tube pump or a bellows pump.

One end of the air communication passage 22 exists in the air space 13b of the ink tank 13, and the other end exists in the outside of the ink tank 13, that is, in the air. The electromagnetic valve 23 opens and closes the air communication passage 22.

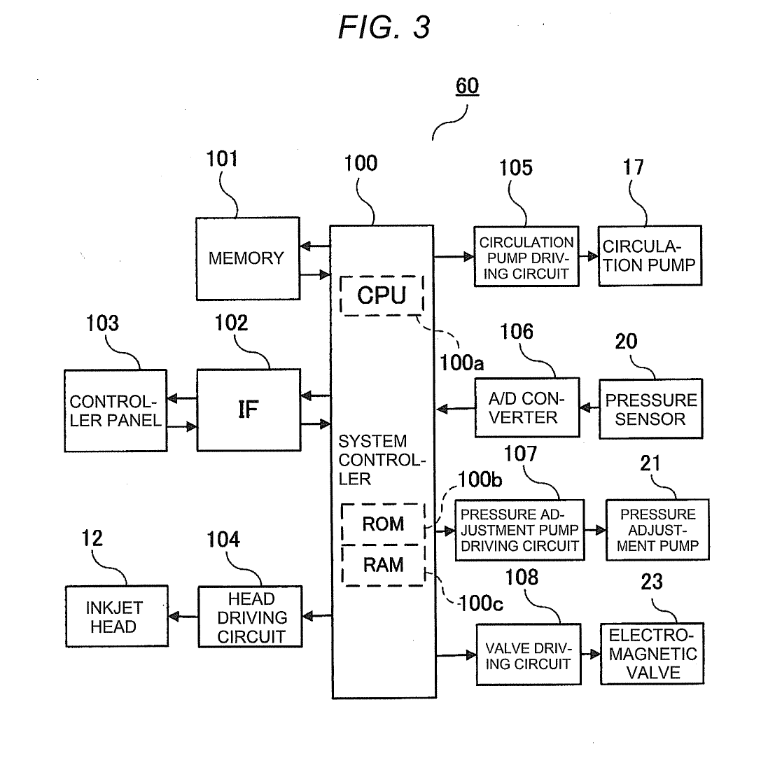

With reference to the block diagram illustrated in FIG. 3, a control system 60 that mainly controls the ink circulation mechanism 10 of the inkjet printer 50 is described. The control system 60 includes, for example, a system controller 100 that controls the entire body of the inkjet printer 50, a memory 101, an interface (I/F) 102, and a control panel 103. The control system 60 includes a head driving circuit 104 that drives the inkjet head 12, a circulation pump driving circuit 105 that drives the circulation pump 17, an A/D converter 106 that converts the detection result of the pressure sensor 20, a pressure adjustment pump driving circuit 107 that controls a pressure adjustment pump 21, and a valve driving circuit 108 that controls the electromagnetic valve 23.

The system controller 100 includes a Central Processing Unit (CPU) 100a, a Read Only Memory (ROM) 100b, and a Random Access Memory (RAM) 100c. The system controller 100 executes various processes of an inkjet printer 50 including a process relating to the circulation of the ink 15 in a circulation channel 10a of an ink circulation mechanism 10. The various processes are realized by executing a computer program stored in the ROM 100b or the like by the CPU 100a.

The memory 101 stores image data to be a print target. The image data may be data received from the external device connected to the inkjet printer 50, and may be data read by a scanner included in the inkjet printer 50, or the like. The interface (I/F) 102 is, for example, an I/O port, and relays data transmission and reception performed between the control panel 103 and the system controller 100. The control panel 103 includes various operation buttons, touch panels, and the like.

The head driving circuit 104 drives the inkjet head 12 corresponding to the command of the system controller 100. For example, if the command from the system controller 100 is to control the printing of an image, the head driving circuit 104 selectively drives the actuator 34 of the inkjet head 12 according to the image data stored in the memory 101, and forms an image on a recording medium.

The circulation pump driving circuit 105 drives the circulation pump 17 according to a command from the system controller 100. The A/D converter 106 performs A/D conversion on an analog signal output by the pressure sensor 20, and outputs a digital signal generated by the conversion to the system controller 100. The pressure adjustment pump driving circuit 107 drives the pressure adjustment pump 21 corresponding to the command from the system controller 100. The valve driving circuit 108 opens and closes the electromagnetic valve 23 according to the control of the system controller 100.

The inkjet printer 50 circulates the ink 15 of the circulation channel 10a in the ink circulation mechanism 10, for example, when power supply is input or when the inkjet printer returns from a power saving mode. The inkjet printer 50 circulates the ink 15 of the circulation channel 10a and removes bubbles or foreign substances mixed in the ink 15.

According to the first embodiment, the pressure in the ink chamber 36 of the inkjet head 12 is increased when the driving of the circulation pump 17 in the ink circulation mechanism 10 is started. Even if the pressure in the ink chamber 36 is increased, and the absorption pressure when the driving of the circulation pump 17 is started is too strong, the bubbles are prevented from being absorbed from the nozzle 33a.

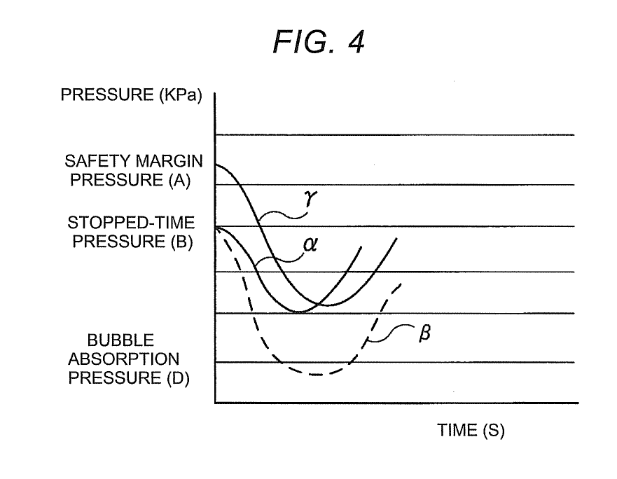

A principle of the first embodiment is described with reference to FIG. 4. The pressure in the ink chamber 36 when the inkjet head 12 is stopped maintains negative pressure in a degree in which the ink 15 is not leaked from the nozzle 33a, and the bubbles are not absorbed from the nozzle 33a. The negative pressure is a pressure when the atmospheric pressure is caused to be zero. The inkjet head 12 maintains the ink chamber 36 to be in the negative pressure, and the leakage of the ink 15 from the ink chamber 36 is prevented by the meniscus generated in the nozzle 33a. When the circulation of the ink 15 in the circulation channel 10a is started, the pressure in the ink chamber 36 of the inkjet head 12 is decreased compared to when the circulation is stopped. For example, if the pressure in the ink chamber 36 is equal to or lower than a bubble absorption pressure D (kPa) when the circulation is started, the bubbles are absorbed from the nozzle 33a.

When the circulation is started, if the pressure in the ink chamber 36 is decreased by the absorption pressure of the circulation pump 17, for example, as indicated by a solid line α, the pressure in the ink chamber 36 does not reach the bubble absorption pressure D (kPa), the bubbles from the nozzle 33a are not attracted. On the other hand, for example, if the pressure in the ink chamber 36 is greatly decreased by the absorption pressure of the circulation pump 17 as indicated by a dotted line β, the pressure in the ink chamber 36 is greatly decreased, the pressure is decreased to be equal to or lower than the bubble absorption pressure D (kPa), and the bubbles are absorbed from the nozzle 33a.

According to the first embodiment, when the driving of the circulation pump 17 is started, the pressure in the ink chamber 36 is increased from a stopped-time pressure B (kPa) to a safety margin pressure A (kPa). If the pressure in the ink chamber 36 is increased to the safety margin pressure A (kPa), even if the absorption pressure when the driving of the circulation pump 17 is started is great, and the pressure in the ink chamber 36 is decreased as indicated by a solid line γ. Even if the absorption pressure when the driving of the circulation pump 17 is started is great, the pressure in the ink chamber 36 is prevented from being decreased to be equal to or lower than the bubble absorption pressure D (kPa). As long as the ink chamber 36 is maintained to be in the negative pressure, the safety margin pressure A (kPa) is optional according to characteristics of the inkjet head 12.

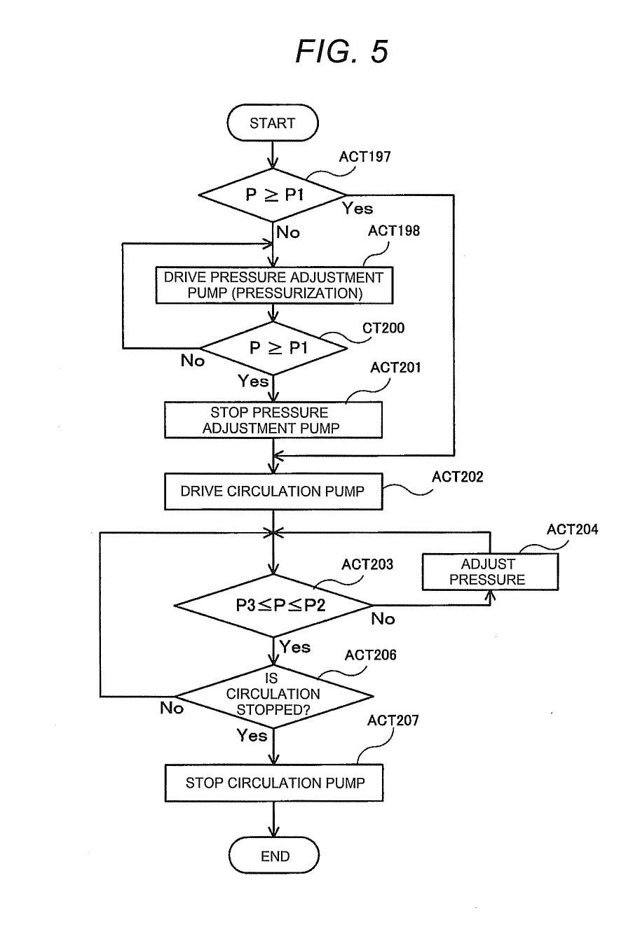

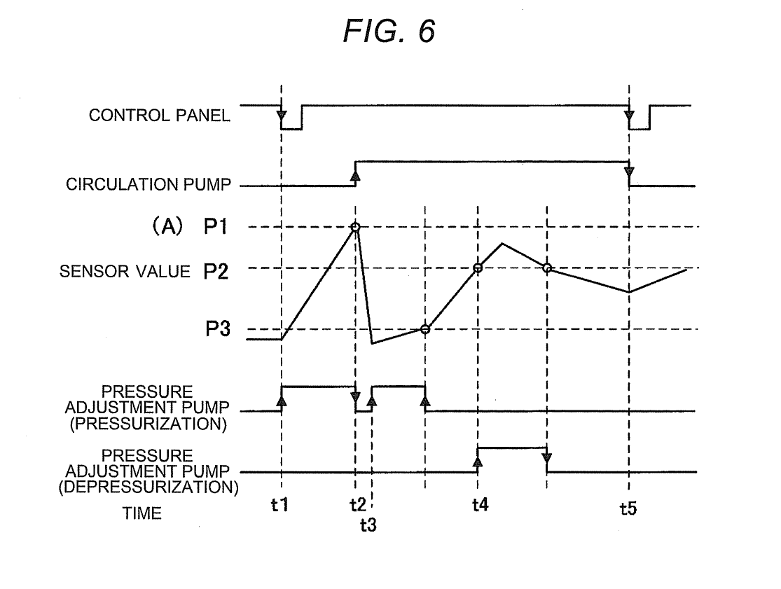

Control of the circulation of the ink 15 by the ink circulation mechanism 10 is described with respect to FIGS. 5 and 6. For example, if an instruction of circulating the ink 15 is input from the control panel 103 at a time t1 in FIG. 6, the ink circulation mechanism 10 starts circulation of the ink 15. The circulation of the ink 15 may be started by switching on the power supply of the inkjet printer 50. The system controller 100 determines whether a pressure value P in the ink tank 13 which is detected by the pressure sensor 20 reaches a threshold value P1 (ACT 197). If the pressure value P in the ink tank 13 is the threshold value P1, the pressure in the ink chamber 36 of the inkjet head 12 becomes the safety margin pressure A (kPa).

After the circulation of the ink 15 is started, if the pressure value P in the ink tank 13 reaches the threshold value P1 (Yes in ACT 197), the system controller 100 proceeds to ACT 202 and drives the circulation pump 17 at a rated flow rate.

If the pressure value P does not reach the threshold value P1 (No in ACT 197), the system controller 100 increases the pressure in the ink tank 13 (ACT 198). The system controller 100 increases the pressure in the ink tank 13 by controlling the pressure adjustment pump driving circuit 107 so that the pressure adjustment pump 21 is driven to increase the pressure (ACT 198). Otherwise, the system controller 100 may increase the pressure in the ink tank 13 by controlling the valve driving circuit 108 so as to drive the electromagnetic valve 23. The pressure in the ink tank 13 is increased through the air communication passage 22 by driving the electromagnetic valve 23.

If the pressure value P in the ink tank 13 reaches the threshold value P1 at a time t2 (Yes in ACT 200), the system controller 100 stops the pressure adjustment pump 21 (ACT 201), and starts to drive the circulation pump 17 (ACT 202). The system controller 100 controls the circulation pump driving circuit 105 so as to drive the circulation pump 17 at the rated flow rate. The circulation pump 17 is started to be driven, and starts to circulate the ink 15 in the circulation channel 10a at the rated flow rate in the direction of the arrow s.

If the pressure value P in the ink tank 13 reaches the threshold value P1, the pressure in the ink chamber 36 becomes the safety margin pressure A (kPa). If the pressure value P in the ink tank 13 reaches the threshold value P1, even if the absorption pressure of the circulation pump 17 is strong when the ink 15 starts to circulate at the rated flow rate, the pressure in the ink chamber 36 is not decreased to be equal to or lower than the bubble absorption pressure D (kPa). When the ink 15 starts to circulate, the bubbles are not absorbed from the nozzle 33a to the ink chamber 36 of the inkjet head 12.

Thereafter, while causing the pressure value P in the ink tank 13 to satisfy P3≦P≦P2, the system controller 100 continues the circulation of the ink 15 (ACTS 203 and 204). In the inkjet head 12, if the pressure value P in the ink tank 13 is in the scope of P3≦P≦P2, the ejection amount and the ejection speed of the ink drop from the nozzle 33a are stabilized and a prominent ink ejection property can be obtained.

A pressure value P2 in the ink tank 13 is a maximum value of the pressure scope in which the inkjet head 12 can exhibit the prominent ink ejection performance when the ink 15 is circulated. A pressure value P3 in the ink tank 13 is a minimum value of the pressure scope in which the inkjet head 12 can exhibit the prominent ink ejection performance when the ink 15 is circulated. The pressure values P2 and P3 in the ink tank 13 are optional according to characteristics of the inkjet head 12, and are not limited to a specific value.

If the pressure value P in the ink tank 13 is not in the scope of P3≦P≦P2 (No in ACT 203), the system controller 100 adjusts the pressure in the ink tank 13 (ACT 204). The system controller 100 adjusts the pressure in the ink tank 13 by controlling the pressure adjustment pump driving circuit 107 so that the pressure adjustment pump 21 is driven to increase or decrease the pressure (ACT 204). Otherwise, the system controller 100 may adjust the pressure in the ink tank 13 by controlling the valve driving circuit 108 so as to drive the electromagnetic valve 23.

For example, if the pressure value P is less than the pressure value P3 at a time t3, the pressure adjustment pump driving circuit 107 increases the pressure in the ink tank 13 by driving the pressure adjustment pump 21 to increase the pressure (ACT 204). For example, if the pressure value P is equal to or greater than the pressure value P2 at a time t4, the pressure adjustment pump driving circuit 107 decreases the pressure in the ink tank 13 by driving the pressure adjustment pump 21 to decrease the pressure (ACT 204).

Since the pressure in the ink tank 13 is maintained in the scope of P3≦P≦P2, while the circulation of the ink 15 continues (ACTS 203, 204, and 206), the foreign substance in the ink 15 of the circulation channel 10a is removed from the filter 18. The bubbles mixed in the ink 15 are collected into the ink tank 13 and absorbed into the air space 13b in the ink tank 13.

For example, if a user instructs to stop circulating the ink 15 from the control panel 103 at a time t5, the system controller 100 determines to stop the circulation of the ink 15 (Yes in ACT 206). By the determination of stopping the circulation (Yes in ACT 206), the system controller 100 stops the circulation pump 17 by controlling the circulation pump driving circuit 105 (ACT 207). The system controller 100 may determine to stop the circulation of the ink 15 at the time t5 not by the instruction of the user, but by a passage of a certain time from the start of the circulation of the ink 15. The system controller 100 ends the control of the circulation of the ink 15 of the ink circulation mechanism 10 by stopping the circulation pump 17 in ACT 207.

According to the first embodiment, bubbles, foreign substances, or the like included in the ink 15 are removed by circulating the ink 15 in the circulation channel 10a by the ink circulation mechanism 10. It is possible to enhance a quality of the image printed by the inkjet printer 50 by favorably maintaining the ink ejection performance of the inkjet head 12.

According to the first embodiment, when the circulation pump 17 of the ink circulation mechanism 10 is started be driven, the pressure in the ink chamber 36 of the inkjet head 12 is increased to the safety margin pressure A (kPa) in advance by increasing the pressure value P in the ink tank 13 to the threshold value P1. Though the pressure of the ink chamber 36 is decreased by the absorption pressure due to the start of the driving of the circulation pump 17, it is possible to maintain the pressure in the scope in which the bubbles from the nozzle 33a are not attracted without causing the pressure to be equal to or lower than the bubble absorption pressure D (kPa). In the inkjet head 12, it is possible to prevent the bubbles from being absorbed from the nozzle 33a regardless of the absorption pressure when the circulation of the ink 15 is started. The ink circulation mechanism 10 favorably maintains the ink ejection performance of the inkjet head 12 by preventing the bubbles from being mixed again into the ink 15 when the circulation of the ink 15 is started so that the quality of the printed image is enhanced.

### Second Embodiment

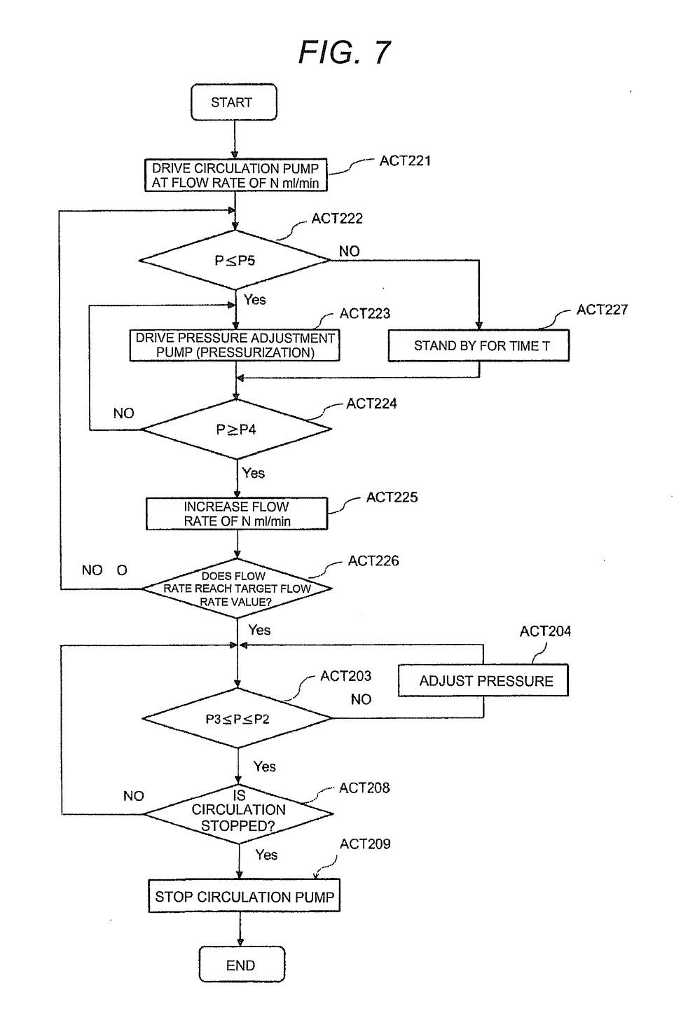

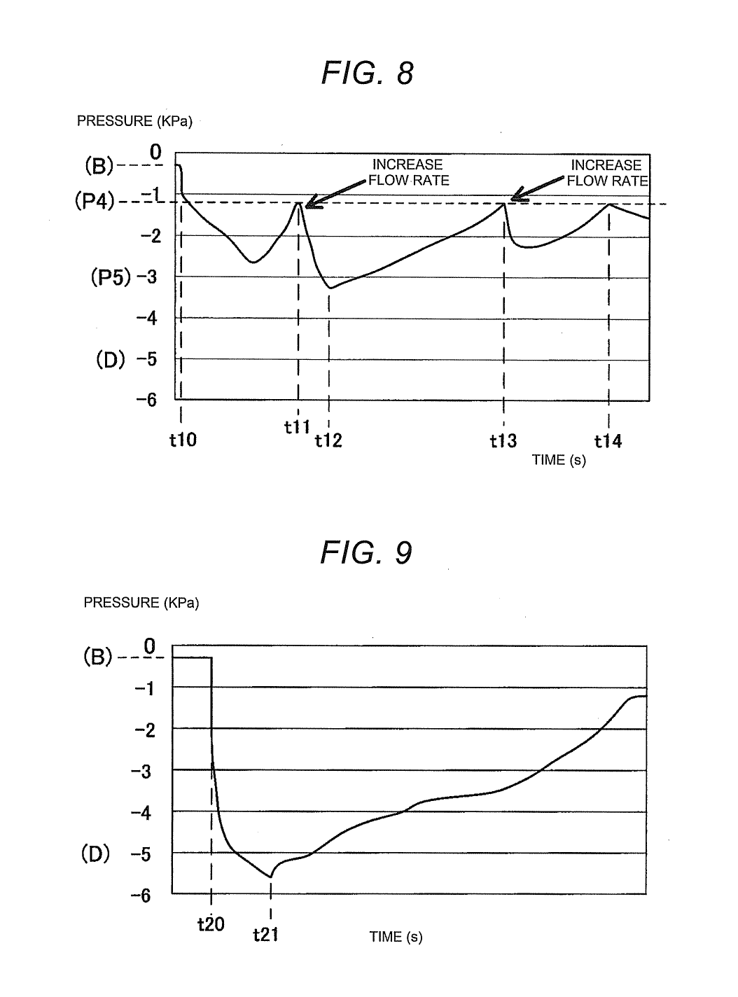

The inkjet printer according to the second embodiment is described with reference to FIGS. 7 and 8. The second embodiment can be obtained by controlling the pressure value and the circulation flow rate in the ink tank when the circulation of the ink is started further to the first embodiment. According to the second embodiment, the same configurations with the configurations described in the first embodiment are denoted by the same reference numerals and the detailed descriptions are not provided.

According to the second embodiment, for example, if the instruction of the circulation of the ink 15 is input from the control panel 103, the ink circulation mechanism 10 starts the circulation of the ink 15.

The system controller 100 drives the circulation pump 17 according to the flow chart illustrated in FIG. 7 (ACT 221). The system controller 100 drives the circulation pump 17 so that the flow rate of the ink 15 that circulates the circulation channel 10a of the ink circulation mechanism 10 becomes N (ml/min) by controlling the circulation pump driving circuit 105 (ACT 221).

If a rated flow rate of the ink 15 that circulates the circulation channel 10a of the ink circulation mechanism 10 is set to be F (ml/min), the flow rate N (ml/min) of the ink 15 is, for example, a value obtained by dividing a rated flow rate F by the number of divisions X (N=F/X). The flow rate N (ml/min) of the ink 15 is a flow rate having a size that does not cause the pressure in the ink chamber 36 to be equal to or lower than the bubble absorption pressure D (kPa) when the circulation of the ink 15 is started regardless of the pressure value of the stopped-time pressure B (kPa) of the inkjet head 12 illustrated in FIG. 4. The flow rate N (ml/min) of the ink 15 is optional according to characteristics of the inkjet head 12.

After circulating the ink 15 in a circulation channel 10a by driving the circulation pump 17, the system controller 100 determines whether the pressure value P in the ink tank 13 reaches a minimum pressure value P5 (ACT 222).

The minimum pressure value P5 is a pressure value that causes the pressure value in the ink chamber 36 of the inkjet head 12 to have a margin to reach the bubble absorption pressure D (kPa) of FIG. 4. Even if the pressure value P in the ink tank 13 is slightly decreased from the minimum pressure value P5, the inkjet head 12 does not reach the bubble absorption pressure D (kPa) for a while, and does not absorb the bubbles from the nozzle 33a. The minimum pressure value P5 of the ink tank 13 is optional according to characteristics of the inkjet head 12, and is not limited to a specific value.

If the pressure value P in the ink tank 13 does not decrease to the minimum pressure value P5 (No in ACT 222), the system controller 100 proceeds to ACT 227 in order to standby for a time T. The circulation pump 17 and the inkjet head 12 of the ink circulation mechanism 10 are directly connected to each other though the ink circulation channel 16. Therefore, when the circulation of the ink 15 starts in the circulation channel 10a, or the flow rate of the ink 15 of the circulation channel 10a increases, the pressure in the ink tank 13 decreases. However, if a certain period of time passes, since the ink 15 is supplied to the inkjet head 12 through the ink supply path 14, the pressure value in the ink tank 13 gradually returns. As the certain period of time passes, the pressure value in the ink tank 13 converges on a certain pressure value. After standing by for the time T for which the pressure value in the ink tank 13 converges on a certain pressure value in ACT 227, the system controller 100 proceeds to ACT 224. The time T until the pressure value in the ink tank 13 converges on a certain pressure value is optional according to characteristics of the ink circulation mechanism 10, and is not limited to a specific value.

If the pressure value P in the ink tank 13 is equal to or lower than the minimum pressure value P5 (Yes in ACT 222), the system controller 100 increases the pressure in the ink tank 13 (ACT 223). The system controller 100 increases the pressure of the ink tank 13, for example, by the difference between the pressure value P detected by the pressure sensor 20 and the minimum pressure value P5 by controlling the pressure adjustment pump driving circuit 107 so that the pressure adjustment pump 21 is driven to increase the pressure (ACT 223). Subsequently, the system controller 100 proceeds to ACT 224.

In ACT 224, if the pressure value P in the ink tank 13 reaches a return pressure value P4 (Yes in ACT 224), the system controller 100 proceeds to ACT 225. If the pressure value P in the ink tank 13 does not reach the return pressure value P4 (No in ACT 224), the system controller 100 proceeds to ACT 223, and increases the pressure in the ink tank 13. The return pressure value P4 is a pressure value to be a criterion for a timing of increasing the flow rate of the ink 15 that circulates in the circulation channel 10a.

The return pressure value P4 is a high pressure value to a degree in which the pressure in the ink chamber 36 does not decrease to the bubble absorption pressure D (kPa) even if the flow rate of the ink 15 that circulates in the circulation channel 10a increases later.

If the pressure value P in the ink tank 13 is the return pressure value P4, the pressure in the ink chamber 36 of the inkjet head 12 is maintained to be the negative pressure with respect to the atmospheric pressure, and the nozzle 33a do not absorb the bubbles. The return pressure value P4 in the ink tank 13 is optional according to characteristics of the inkjet head 12, and is not limited to a specific value.

In ACT 225, the system controller 100 increases the flow rate of the ink 15 that circulates the circulation channel 10a of the ink circulation mechanism 10 by N (ml/min). In the same manner as in ACT 221, the system controller 100 drives the circulation pump 17 by controlling the circulation pump driving circuit 105 (ACT 225).

After the flow rate of the ink 15 is increased by N (ml/min) in ACT 225, the system controller 100 determines whether the flow rate of the ink 15 that circulates the circulation channel 10a reaches the rated flow rate F (ml/min) (ACT 226).

The flow rate of the ink 15 is determined by an output value of the pressure sensor 20 or a driving command sent by the system controller 100 to the circulation pump driving circuit 105. If the flow rate of the ink 15 that circulates the circulation channel 10a does not reach the rated flow rate F (ml/min) (No in ACT 226), the system controller 100 proceeds to ACT 222. The system controller 100 gradually increases the flow rate of the ink 15 by executing ACTS 222 to 227 until the flow rate of the ink 15 that circulates the circulation channel 10a reaches the rated flow rate F (ml/min).

If the flow rate of the ink 15 that circulates the circulation channel 10a reaches the rated flow rate F (ml/min) (Yes in ACT 226), the system controller 100 executes ACTS 203, 204, 206, and 207 in the same manner as in the first embodiment. The system controller 100 ends the circulation of the ink 15 of the ink circulation mechanism 10 by stopping the circulation pump 17 in ACT 207.

According to the second embodiment, the pressure fluctuation in the ink chamber 36 of the inkjet head 12 when the driving of the circulation pump 17 is started is illustrated in FIG. 8. For example, the stopped-time pressure B (kPa) of the ink chamber 36 of the inkjet head 12 is set to be −0.3 (kPa). The pressure value of the ink chamber 36 when the ink tank 13 is in the return pressure value P4 is set to be −1.2 (kPa), and the pressure of the ink chamber 36 when the ink tank 13 is in the minimum pressure value P5 is set to be −3.0 (kPa). The bubble absorption pressure D (kPa) of the ink chamber 36 of the inkjet head 12 is set to be −5.0 (kPa).

According to ACT 221, the circulation of the ink 15 is started at the flow rate N (ml/min) in the circulation channel 10a at a time t10. The pressure of the ink chamber 36 by the absorption pressure of the circulation pump 17 gradually returns after being decreased from −0.3 (kPa) to, for example, −2.5 (kPa). According to ACT 224, if the pressure value in the ink tank 13 is detected to reach the return pressure value P4 (time t11), the pressure of the ink chamber 36 returns up to −1.2 (kPa).

According to ACT 225, the flow rate of the ink 15 in the circulation channel 10a is increased by N (ml/min) at the time t11. If the pressure value in the ink tank 13 decreases, for example, to the minimum pressure value P5 by increasing the flow rate of the ink 15 (time t12), the pressure in the ink tank 13 is increased according to ACT 223. The ink chamber 36 is prevented from reaching −5.0 (kPa) which is the bubble absorption pressure D (kPa) by increasing the pressure in the ink tank 13 in advance.

After the pressure in the ink tank 13 is increased, according to ACT 224, it is detected whether the pressure value in the ink tank 13 reaches the return pressure value P4 (time t13), if the pressure of the ink chamber 36 returns up to −1.2 (kPa), the flow rate of the ink 15 of the circulation channel 10a is increased by N (ml/min)

In the same manner, if the pressure value of the ink chamber 36 is equal to or lower than the minimum pressure value P5, while the pressure in the ink tank 13 is increased, the increase of the flow rate of the ink 15 is repeated X times. After the flow rate of the ink 15 that circulates the circulation channel 10a reaches the rated flow rate F (ml/min) by repeating the increase of the flow rate of the ink 15 X times (Yes in ACT 226), the ink 15 is circulated at the rated flow rate F (ml/min).

The foreign substances mixed in the ink 15 of the circulation channel 10a are removed from the filter 18, while the ink 15 is circulated at the rated flow rate F (ml/min) (ACT 203, 204, and 206). The bubbles mixed into the ink 15 is collected in the ink tank 13, and absorbed into the air space 13b in the ink tank 13.

According to the second embodiment, the pressure fluctuation of the ink chamber 36 when the circulation of the ink at the rated flow rate F is started from an ink stopped state is illustrated in FIG. 9 as a comparative example. If the circulation of the ink 15 starts at the rated flow rate F (ml/min) in the circulation channel 10a at a time t20, after the pressure of the ink chamber 36 by the absorption pressure of the circulation pump 17 drastically decreases from −0.3 (kPa), for example, to −5.5 (kPa) (time t21), the pressure of the ink chamber 36 gradually returns. However, since the pressure of the ink chamber 36 is equal to or lower than −5.0 (kPa) of the bubble absorption pressure D (kPa) at the time t21, the bubbles may be mixed from the nozzle 33a.

According to the comparative example, the pressure of the ink chamber 36 is drastically decreased in order to suddenly circulate the ink at the rated flow rate F (ml/min) from the ink stopped state. Meanwhile, according to the second embodiment, the decrease of the pressure of the ink chamber 36 is small since the circulation starts at a low ink flow rate and the ink flow rate is gradually increased to the rated flow rate F (ml/min).

According to the second embodiment, in the same manner as in the first embodiment, it is possible to favorably maintain the ink ejection performance of the inkjet head 12 and enhance the quality of the printed image by removing bubbles or foreign substances included in the ink 15.

According to the second embodiment, the circulation of the ink 15 in the circulation channel 10a at a low ink flow rate is started when the driving of the circulation pump 17 of the ink circulation mechanism 10 is started. After the start of the circulation, while the pressure of the ink chamber 36 of the inkjet head 12 is adjusted, the flow rate of the ink 15 is gradually increased until the flow rate reaches the rated flow rate F (ml/min).

The absorption pressure due to the start of driving the circulation pump 17 of the ink circulation mechanism 10 is alleviated, and the ink chamber 36 drastically decreases the pressure, so that the pressure reaches a value which is equal to or lower than the bubble absorption pressure D (kPa). Regardless of the absorption pressure when the circulation of the ink 15 is started, it is possible to prevent the nozzle 33a of the inkjet head 12 from absorbing the bubbles. Further, when the circulation of the ink 15 is started, it is possible to maintain the pressure in the ink chamber 36 of the inkjet head 12 in a certain appropriate scope.

The liquid ejecting apparatus according to the embodiment described above is not limited to the inkjet printer, and may be used in a facsimile apparatus, a copying machine, or the like that form images in an inkjet method. Further, the liquid ejecting apparatus can eject liquid in addition to the ink. The liquid ejecting apparatus that ejects liquid other than the ink may be an apparatus that ejects liquid including, for example, conductive particles for forming a wiring pattern of the printed wiring board.

According to at least one embodiment described above, it is possible to favorably maintain the ink ejection performance of the inkjet head and enhance the quality of the printed image by circulating the ink by the ink circulation mechanism and removing bubbles, foreign substances, or the like in the ink. The pressure of the ink chamber 36 is decreased by the absorption pressure by the start of driving of the circulation pump 17, but the pressure in the ink chamber when the circulation of the ink is started is appropriately maintained and the absorption of the bubbles from the nozzle is prevented so that it is possible to provide the printed image in a good quality by the prominent ink ejection performance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid ejecting apparatus comprising:
a liquid ejecting head that ejects liquid from an ejection portion;
a tank that stores the liquid;
a circulation transportation portion that includes a first transportation portion for transporting liquid from the tank to the liquid ejecting head, and a second transportation portion for transporting the liquid from the liquid ejecting head to the tank;
an actuator that circulates the liquid of the circulation transportation portion; and
a control portion that controls the actuator so as to maintain pressure in the liquid ejecting head to be negative pressure with respect to atmospheric pressure when circulation of the liquid in the circulation transportation portion is started and to start the circulation of the liquid after the pressure in the liquid ejecting head is increased.

2. The apparatus according to claim 1,
wherein the control portion controls the actuator so as to increase the pressure in the liquid ejecting head by increasing pressure in the tank to a predetermined threshold value when the circulation of the liquid is started.

3. The apparatus according to claim 2,
wherein the control portion controls the actuator so as to start the circulation of the liquid to a rated flow rate.

4. The apparatus according to claim 1,
wherein when the circulation of the liquid is started, the control portion controls the actuator so as to gradually increase the pressure in the liquid ejecting head by gradually increasing the pressure in the tank and to gradually increase the flow rate of the liquid that circulates the circulation transportation portion, so that a flow rate of the liquid to a rated flow rate is increased.

5. The apparatus according to claim 1,
wherein the actuator includes:
a transportation pump that transports the liquid by the circulation transportation portion; and
a pressure adjustment pump that adjusts pressure in the liquid ejecting head.

6. A liquid circulation method of a liquid ejecting apparatus,
wherein when circulation of liquid is started between a liquid ejecting head and a tank, in a state in which pressure in the liquid ejecting head is negative pressure with respect to atmospheric pressure, after the pressure in the liquid ejecting head is increased, the circulation of the liquid is started.

7. The method according to claim 6,
wherein when the circulation of the liquid is started, after the pressure in the liquid ejecting head is increased by increasing the pressure in the tank to a predetermined threshold value, the circulation of the liquid is started.

8. The method according to claim 7,
wherein when the circulation of the liquid is started, the circulation of the liquid is started at a rated flow rate.

9. The method according to claim 6,
wherein when the circulation of the liquid is started, the pressure in the liquid ejecting head is gradually increased by gradually increasing the pressure in the tank, and a flow rate in the circulating liquid is gradually increased to a rated flow rate.
